(19) United States
(12) Patent Application Publication
(10) Pub. No.: US 2020/0205419 A1
(43) Pub. Date: Jul. 2, 2020

(54) MULTI-CONVEYOR SLAVE DRIVE MECHANISM

(71) Applicant: Dorner Mfg. Corp., Hartland, WI (US)

(72) Inventor: Daniel E. Ertel, Oconomowoc, WI (US)

(73) Assignee: Dorner Mfg. Corp., Hartland, WI (US)

(21) Appl. No.: 16/237,884

(22) Filed: Jan. 2, 2019

(51) Int. Cl. A21B 1/48; B65G 21/22

(52) U.S. Cl. CPC A21B 1/48; B65G 21/22

(57) ABSTRACT

A multi-section conveyor assembly for moving food products through an oven enclosure for cooking is disclosed. The conveyor assembly includes a first conveyor section, a second conveyor section and a third conveyor section each of which have a separate conveyor belt. The first and second conveyor sections are linked to each other by a first gear box while the second and third conveyor sections are linked to each other with a second gear box. The first and second gear boxes allow a single drive motor to rotate a driven shaft of one of the conveyor sections. The rotation of the driven shaft is transferred between the conveyor sections through the first and second gear boxes. The first and second gear boxes can be quickly and easily removed from the conveyor assembly for ease of disassembly and cleaning.

### BACKGROUND

The present disclosure generally relates to a conveyor assembly for use in moving food products through an oven for cooking. More specifically, the present disclosure relates to a multi-section conveyor including a slave drive mechanism to interconnect each of the conveyor sections.

Presently, many different types of ovens exist that include a conveyor for moving food products through an oven enclosure for baking or heating the food product. These conveyor assemblies are typically constructed including a single section conveyor frame having a conveyor belt that moves along the length of the conveyor between two end rollers and is driven by a drive motor. The continuous conveyor belt is formed from a metallic material that can withstand the temperatures within the oven enclosure.

Although such conveyors function well to move food product through the oven enclosure, cleaning the conveyor assembly requires removing the entire length of the conveyor from the oven enclosure. Such cleaning process requires sufficient space at one or both ends of the oven since the conveyor must be removed as a single unit.

Therefore, the inventors have identified a need for an improved conveyor assembly that allows the conveyor assembly to be removed in sections for both the ease of cleaning and for the ease of disassembly. The inventors have recognized that utilizing a single drive motor remains most desirable to reduce the cost and operating complexity of the conveyor assembly. Therefore, in accordance with the present disclosure, a conveyor assembly is provided having multiple conveyor sections that are linked to each other by one or more slave drive mechanisms such that a single drive motor can impart rotation to the conveyor belts of each of the plurality of conveying sections.

### SUMMARY

The present disclosure relates to a multi-section conveyor assembly that includes slave drive mechanisms to interconnect each of the conveyor sections such that the conveyor assembly can be operated by a single drive motor.

The conveyor assembly of the present disclosure includes first and second conveyor sections that combine to move a food product from an infeed end to a discharge end. The conveyor assembly can be positioned within an oven enclosure such that the food product is heated or baked as the food product moves through the oven enclosure along the conveyor belts.

The first conveyor section includes a driven shaft and an idler shaft that are rotatably supported between a pair of spaced side frames and are coupled to each other by a first conveyor belt. The first conveyor belt interconnects the pair of spaced shafts such that rotation of the driven shaft imparts rotation to the idler shaft.

A second conveyor section is positioned adjacent to the first conveyor section and includes a first connecting shaft and a second connecting shaft that are rotatably supported between a pair of spaced side frame members. The first and second connecting shafts are coupled to each other by a second conveyor belt.

The conveyor assembly includes a gear box that is positioned between the idler shaft of the first conveyor section and the first connecting shaft of the second conveyor section such that rotation of the idler shaft imparts rotation to the first connecting shaft through the gear box. In this manner, the gear box is able to transfer the movement of the first conveyor belt to the second conveyor belt without the need for a second drive motor.

In one contemplated embodiment of the present disclosure, a third conveyor section can be incorporated in the conveyor assembly. The third conveyor section includes a similar first connecting shaft and a second connecting shaft that are rotatably supported between a pair of spaced side frame members. The first and second connecting shafts are coupled to each other by a third conveyor belt. In accordance with the exemplary embodiment, a second gear box having the same configuration as the first gear box, is positioned between the second conveyor section and the third conveyor section. The second gear box includes similar components and interconnects the second connecting shaft of the second conveyor section to the first connecting shaft of the third conveyor section. The use of the second gear box transfers the rotational movement of the second conveyor belt to the third conveyor belt without the need for an additional drive motor.

In accordance with an exemplary embodiment of the present disclosure, the gear boxes utilized to transfer rotation between conveyor sections include a first coupling member and a second coupling member that are each rotatably supported within the gear box. The first and second coupling members each include a shaft portion and a head portion. The head portion is rotatably supported within the gear box through a bearing assembly. Each of the first and second coupling members includes a sprocket fixed to the shaft portion. The pair of sprockets are linked to each other by a linking chain such that rotation of one of the connecting members results in rotation of the other connecting member.

The interconnection between the first and second coupling members in each of the gear boxes along with the use of a linking chain allows the gear box to compensate for expansion and contraction of the conveyor sections when used within oven enclosure. Each of the first and second gear boxes are not fixed to the conveyor sections which allows for the ability to compensate for the expansion and contraction. The first and second gear boxes can be easily removed from the conveyor assembly without the need for any additional tooling. When the gear box is removed, the conveyor sections can be separated and serviced as desired. The use of the separate gear boxes allows for the conveyor assembly to be separated and cleaned without the need to remove the entire conveyor assembly from the oven.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is a top perspective view of an oven incorporating the conveyor assembly of the present disclosure;

FIG. 2 is a top perspective view of the conveyor assembly with the individual conveyor belts removed;

FIG. 3 is an exploded view of the conveyor assembly with the conveyor belts removed;

FIG. 4 is a partially exploded, magnified view illustrating the interaction between a gear box and two conveyor sections;

FIG. 5 is an exploded view of the gear box;

FIG. 6 is a front perspective view of the gear box; and

FIG. 7 is a front perspective view of the gear box with a portion of the housing removed.

### DETAILED DESCRIPTION

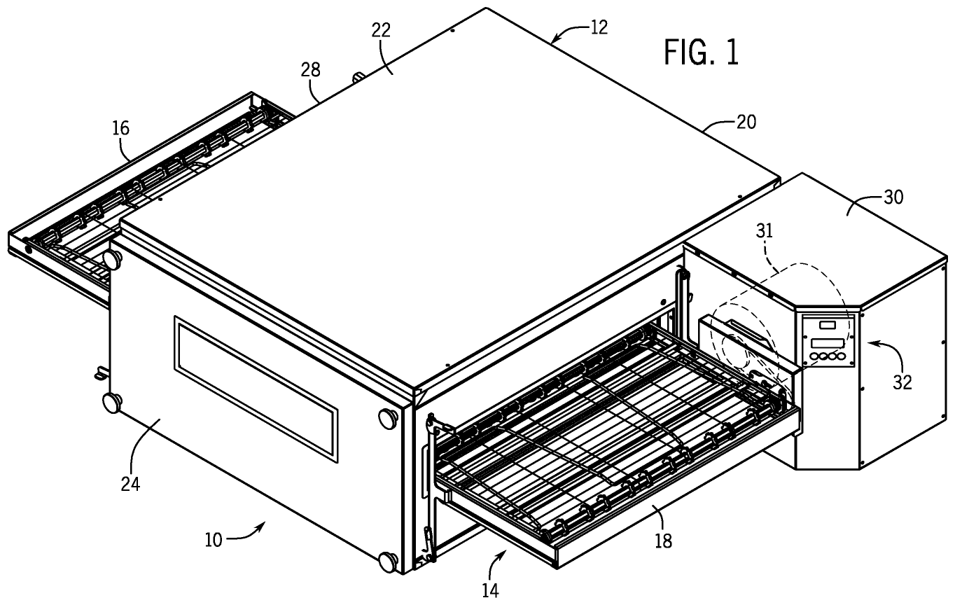

FIG. 1 illustrates an oven 10 that is operable to cook food products as the food products move through an oven enclosure 12 through operation of a conveyor assembly 14. The conveyor assembly 14 operates to move a food product, such as a pizza, from an infeed end 16 to a discharge end 18. The oven enclosure 12 includes electrically operated resistive heating elements, or other similar heating elements, that bake the food product as the food product moves through the oven enclosure 12. The oven enclosure 12 defines an outer housing 20 having a top wall 22, a pair of side walls 24, a front wall 26 and a back wall 28. The front wall 26 and the back wall 28 include openings that allow the conveyor assembly 14 to be removed and cleaned as desired.

The oven 10 further includes a motor and control housing 30 that encloses an operating electric drive motor 31 that drives movement of the conveyor assembly 14 to move the food product through the oven 10. The motor and control housing further includes the control components needed to control the operation of the drive motor 31 and the resistive heating elements contained within the oven enclosure 12. A control panel 32 is provided to allow an operator to control settings related to the operation of the drive motor and the temperature resistive heating elements to control the baking cycle for the food product as the food product passes through the oven enclosure 12.

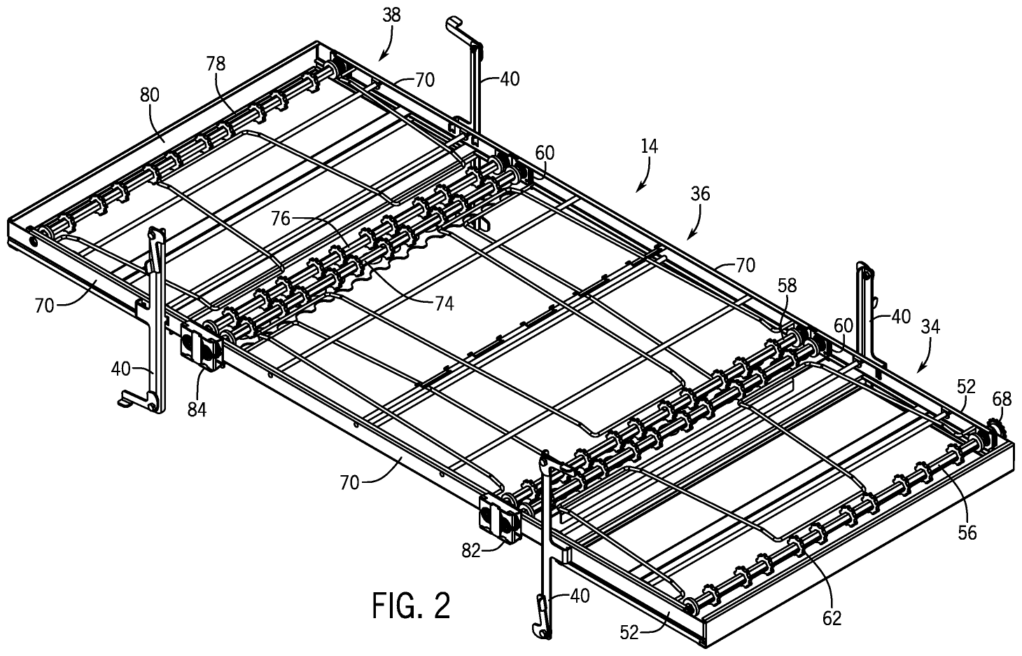

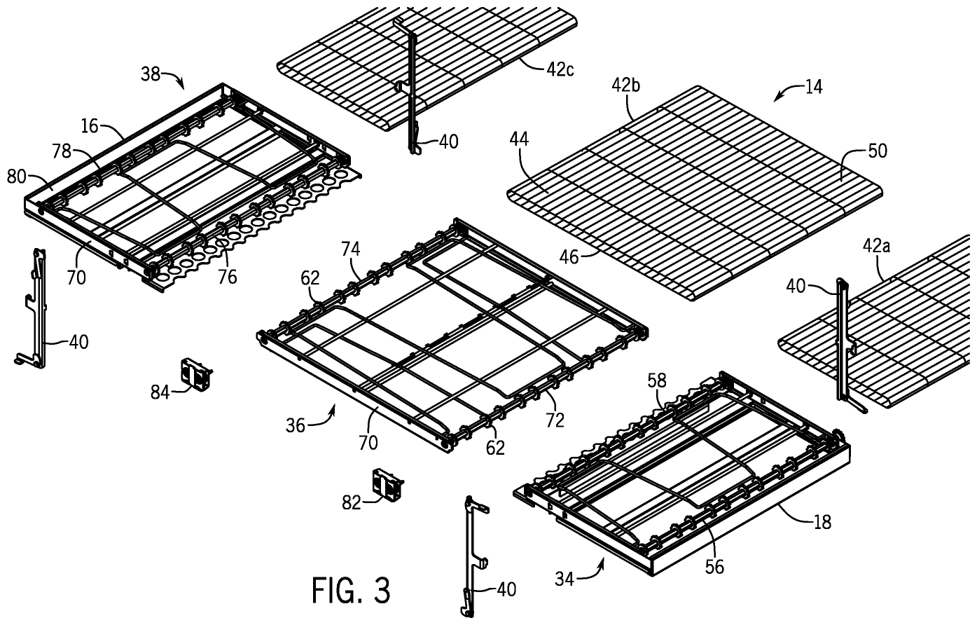

FIGS. 2 and 3 illustrate the conveyor assembly 14 constructed in accordance with the present disclosure in which the individual conveyor belts are removed to show the operative components of the conveyor assembly. As illustrated in FIG. 3, the conveyor assembly 14 includes a first conveyor section 34, a second conveyor section 36 and a third conveyor section 38. The combination of the first, second and third conveyor sections define the overall length of the conveyor assembly 14 from the infeed end 16 to the discharge end 18. The conveyor assembly 14 is supported within the oven enclosure of the oven by four support arms 40. The support arms 40 provide vertical support for the entire conveyor assembly 14 within the oven enclosure 12 as food products are moved through the oven enclosure.

It should be understood throughout the entire disclosure, the temperature within the oven enclosure 12 can reach temperatures in the range of 600° F. in order to bake the pizzas moving through the oven enclosure. Thus, all of the operating components of the conveyor assembly 14 must be able to withstand the temperatures within the oven enclosure 12.

The conveyor sections 34, 36 and 38 are shown in FIGS. 2 and 3 with the conveyor belts removed. As shown in FIG. 3, each conveyor section includes a conveyor belt 42 that can be utilized with the conveyor assembly of the present disclosure. The conveyor belt 42 includes both an upper flight 44 and a lower flight 46 that pass around a pair of spaced shafts. The conveyor belt 42 is formed as a continuous loop from wire sections 50 joined to each other in a tight weave sufficient enough to support the food product as the food product is moved by the conveyor assembly 14 through the oven enclosure. The conveyor belts 42 shown in FIG. 3 are each of conventional construction and have been widely used with baking ovens, such as a pizza oven, for many years.

Referring back to FIGS. 2 and 3, the construction of each of the individual conveyor sections will now be discussed.

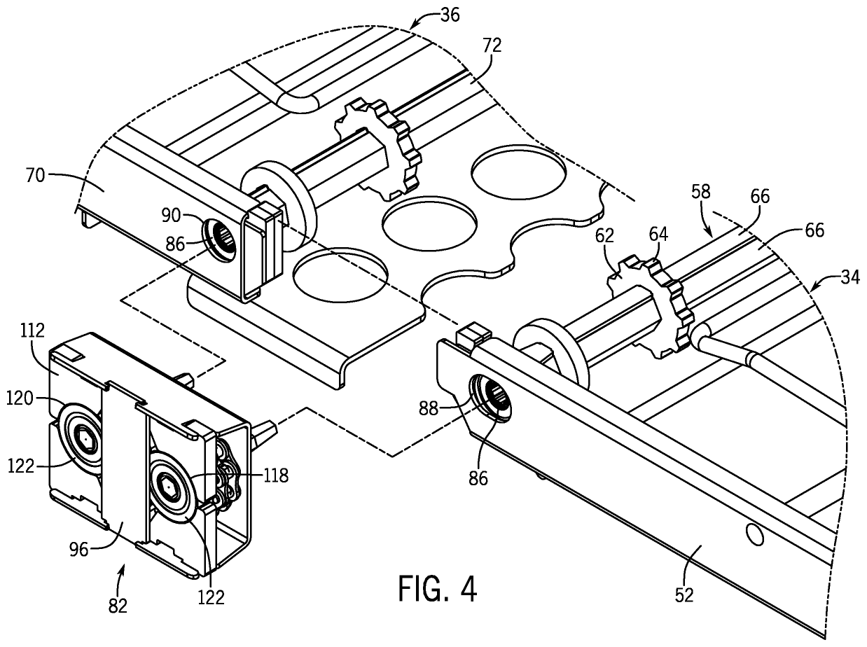

The first conveyor section 34 includes a pair of spaced side frames 52 that define the overall width of the conveyor section. The side frames 52 provide a mounting location for a support grid 54 which is used to support the upper run of the conveyor belt as the conveyor belt moves along the first conveyor section 34. The first conveyor section 34 further includes a driven shaft 56 and an idler shaft 58. Both the driven shaft 56 and the idler shaft 58 are rotatably supported at each end by a mounting block 60. The mounting blocks 60 are each supported along an inside surface of one of the side frames 52. Both the driven shaft 56 and idler shaft 58 include a plurality of sprocket wheels 62 spaced along the length of the shaft. As shown in FIG. 4, each of the sprocket wheels 62 includes a plurality of teeth 64 that are spaced and configured to engage the conveyor belt to impart motion to the conveyor belt as desired. As further shown in FIG. 4, both the driven shaft 56 and the idler shaft 58 are designed to have a series of individual face surfaces 66 such that a cross section of both the driven shaft and idler shaft has a hexagonal cross section. Although this configuration of the driven shaft and idler shaft is shown in the present disclosure, it should be understood that the cross sectional shape of the driven and idler shafts could be varied depending upon the scope of the present disclosure. The idler shaft 58 rotatably engages each of the series of sprocket wheels 62 such that the sprocket wheel 62 rotates along with rotation of the idler shaft 58.

Referring back to FIG. 2, the driven shaft 56 includes a drive gear 68 which is located to the outside of the side frame 52 and is designed to couple the driven shaft 56 to the drive motor contained within the motor and control housing 30 shown in FIG. 1. Through this interaction between the drive gear 68 and the drive motor, the driven shaft 56 is caused to rotate at a speed dictated by the operational controls of the electric drive motor.

When the first conveyor belt 42a is installed on the first conveyor section 34, rotation of the driven shaft 56 will result in rotation of the idler shaft 58. Such rotation will cause food product to move along with the conveyor belt 42a from the upstream end of the first conveyor section to the downstream end of the first conveyor section.

As illustrated in FIG. 2, the second conveyor section 36 includes a similar pair of side frames 70 that each rotatably support a pair of mounting blocks 60 associated with both a first connecting shaft 72 and a second connecting shaft 74. Both the first connecting shaft 72 and the second connecting shaft 74 have the same general function, appearance and configuration as the idler shaft 58 and support a series of spaced sprocket wheels 62 along the length of the respective connecting shaft. As shown in FIG. 3, a similar conveyor belt 42b passes over the first and second connecting shafts 72, 74 and is entrained around the individual teeth contained on each of the sprocket wheels 62.

The third conveyor section 38 is configured in a similar manner to the second conveyor section 36 and includes a pair of spaced side frames 70 that each support a first connecting shaft 76 and a second connecting shaft 78 that combine to move the conveyor belt 42c. The third conveyor section 38 includes the end frame 80 since it is the most upstream portion of the combined conveyor assembly 14.

As can be understood in FIGS. 2 and 3, the entire conveyor assembly 14 includes the multiple conveyor sections 34, 36 and 38. Thus, in order for a food product to move along the entire, combined length of the conveyor assembly 14, the rotation of the conveyor belt 42a in the first conveyor section 34, which includes the driven shaft 56, must be transferred to conveyor belts 42b and 42c of the second conveyor section 36 and the third conveyor section 38.

As indicated above, each of the first, second and third conveyor sections 34, 36 and 38 are separate components that each include a separate conveyor belt. When the conveyor assembly 14 is assembled as shown in FIG. 2, a first gear box 82 is positioned along one side of the conveyor assembly to transfer rotational movement from the first conveyor assembly 34 to the second conveyor assembly 36. A second gear box 84 is positioned between the second conveyor section 36 and the third conveyor section 38 to transfer rotational movement from the second conveyor section 36 to the third conveyor section 38. In this manner, the combination of the first gear box 82 and the second gear box function as separate slave drives to 84 transfer the driven rotational movement from the driven shaft 56 to each of the three conveyor belts supported by the conveyor assembly 14. It should be understood that although three conveyor sections are shown in the embodiments of FIGS. 2 and 3, the conveyor assembly 14 could be modified to include either two conveyor sections or more than three conveyor sections utilizing the design of the present disclosure.

The first and second gear boxes 82 and 84 have an identical design such that the following description for the first gear box 82 will apply to the second gear box 84. As shown in FIG. 2, the idler shaft 58 of the first conveyor section 34 and the first connecting shaft 72 of the second conveyor section 36 are coupled to each other through the first gear box 82. As shown in FIG. 4, the idler shaft 58 and the first connecting shaft 72 have an identical configuration and include an open, hollow interior having a multi-faceted inner surface 86 that extends along the length of the respective shaft. The open interior of the shaft is accessible through an opening 88 formed in the side frame 52 or a corresponding opening 90 formed in the side frame 70. The respective openings 88, 90 allow the first gear box 82 to couple the first conveyor section 34 to the second conveyor section 36.

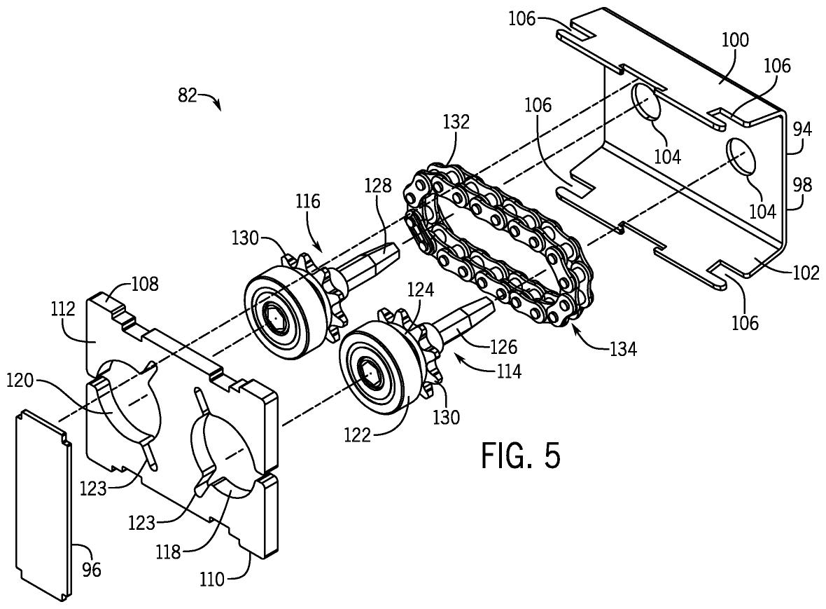

Referring now to FIGS. 5-7, the details of the first gear box 82 are shown. The first gear box 82 includes an outer housing 92 which is formed from a front portion 94 and a back plate 96. The front portion 94 includes a front wall 98 integrally joined with a top wall 100 and a bottom wall 102. In the embodiment illustrated, the front portion 94 is formed from a single piece of stamped metal material in which the top and bottom walls 100, 102 are angled relative to the front wall 98. The front wall 98 includes a pair of front openings 104 that are spaced from each other by the desired spacing between the conveyor sections. The top and bottom walls 100, 102 include a pair of spaced receiving notches 106 that are sized to receive the top and bottom edges 108, 110 of a support block 112. The support block 112 has a sufficient thickness to provide secure and stable support for both a first coupling member 114 and a second coupling member 116. The support block 112 includes a first support opening 118 and a second support opening 120.

As best illustrated in FIG. 5, the first and second coupling members 114, 116 have an identical configuration and each include a bearing assembly 122 mounted to a head portion 124. A shaft portion 126 extends from the head portion 124 and includes a multi-faceted outer surface. The multi-faceted outer surface of the shaft portion 126 is configured to mate and engage with the multi-faceted inner surface 86 of the rotating shafts of each of the conveyor sections. The shaft portion 126 includes a front portion 128 that has a reduced cross section as compared to the rest of the shaft portion 126. The reduced size front portion 128 facilitates insertion of the shaft portion 126 into the open interior of the rotating shafts of the conveyor sections.

As can be seen in FIG. 4, the bearing assemblies 122 are press fit into the respective openings 118 and 120 of the support block 112 and the notches 123 allow the support block to slightly flex during initial installation. The bearing assemblies 122 hold each of the first and second coupling members 114, 116 in place while allowing the head portion 124 and corresponding shaft portion 126 to freely rotate.

Each of the first and second coupling members 114, 116 further includes a sprocket 130 that fixed is rotatable with the shaft portion 126. Each sprocket 130 includes a series of spaced teeth that are sized to engage the individual links 132 of a linking chain 134. The linking chain 134 thus interconnects the first coupling member 114 to the second coupling member 116 such that rotation of the first coupling member 114 results in corresponding rotation of the second coupling member 116.

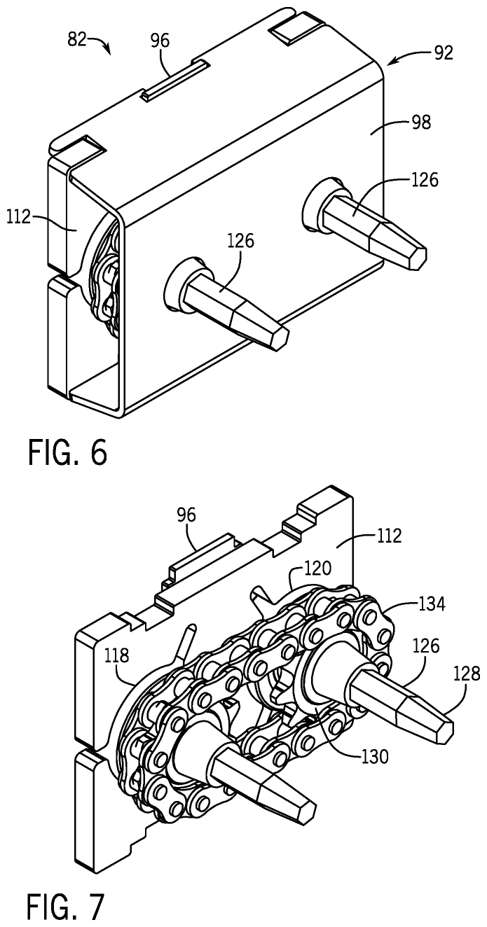

When the gear box 82 is fully assembled, as illustrated in FIG. 6, the pair of shaft portions 126 extend through the front wall 98. In this manner, the pair of shaft portions 126 can be inserted into the open interiors of the idler shaft 58 and the first connecting shaft 72, as illustrated in FIG. 4. Since the outer surface of each shaft portion 126 includes a series of individual facets that correspond to internal facets formed along the open interiors of each of the idler shaft 58 and the first connecting shaft 72, rotation from the idler shaft 58 can be transferred to the first connecting shaft 72 through the gear box 82. In the assembled condition shown in FIG. 6, the back plate 96 holds the support block 112 in position relative to the front portion 94 such that the entire first gear box 82 can be installed between the first conveyor section 34 and the second conveyor section 36 as a single unit.

As can be understood in FIG. 2, the second gear box 84 functions in the same way as the first gear box 82 described above except that the second gear box 84 is positioned between the second conveyor section 36 and the third conveyor section 38. In the same manner as described above, the second gear box 84 transfers the rotation of the second connecting shaft 74 of the second conveyor section 36 to the first connecting shaft 76 of the third conveyor section 38. As can be understood by the conveyor assembly shown in FIG. 2, the rotation imparted to the driven shaft 56 by the drive motor through the drive gear 68 is ultimately transferred to each of the conveyor sections through the first and second gear boxes 82, 84. Each of the first and second gear boxes 82, 84 are constructed of materials that can withstand the baking temperatures within the oven enclosure. Further, the first and second gear boxes 82, 84 are modular components that can be removed to allow disassembly of the entire conveyor assembly without the need for additional tooling. Such disassembly allows for ease of cleaning, maintenance and reduces the overall footprint required near the oven to provide full cleaning of the conveyor assembly.

When the gear box 82 is installed to link the first conveyor section 34 to the second conveyor section 36, the configuration and mounting of the first and second coupling members 114, 116 allow for a degree of expansion and contraction between the metal components of the first and second conveyor sections. Specifically, each of the first and second coupling members 114, 116 are mounted within the first gear box 82 only at the end including the bearing 122. Thus, the opposite, distal end of the rotating shaft can move slightly due to the expansion or contraction of the metal components of the conveyor sections. In addition, the linking chain 134 provides a linking connection between the sprockets 132 to allow for relative movement between the sprockets 130. In this manner, the configuration of the first and second gear boxes 82, 84 provide a flexible connection between the respective conveyor sections as compared to a fixed gear box.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A conveyor assembly for use in moving food products through an oven for cooking, comprising:
a first conveyor section including a driven shaft and an idler shaft each rotatably supported between a pair of spaced side frame members and coupled to each other by a first conveyor belt such that rotation of the driven shaft imparts rotation to the idler shaft;
a second conveyor section including a first connecting shaft and a second connecting shaft each rotatably supported between a pair of space side frame members and coupled to each other by a second conveyor belt; and
a gear box positioned between the idler shaft of the first conveyor section and the first connecting shaft of the second conveyor section such that rotation of the idler shaft imparts rotation to the first connecting shaft through the gear box.

2. The conveyor assembly of claim 1 wherein the gear box includes a first coupling member and a second coupling member each rotatable within the gear box and coupled to each other.

3. The conveyor assembly of claim 2 wherein each of the first and second coupling members includes a shaft portion and a head portion, the shaft portion of the first coupling member being received within an open interior of the idler shaft and the shaft portion of the second coupling member being received within an open interior of the first connecting shaft of the second conveyor section.

4. The conveyor assembly of claim 3 wherein each of the first and second coupling members further comprises a sprocket positioned between the shaft portion and the head portion, each of the sprockets receiving a linking chain.

5. The conveyor assembly of claim 3 wherein the head portion of each of the first and second coupling members includes a bearing that rotatably supports the head portion within a mounting plate.

6. The conveyor assembly of claim 1 wherein the gear box is removably supported between the first and second conveyor sections.

7. The conveyor assembly of claim 5 wherein the gear box includes a housing and the shaft portion of the first and second coupling members extend through the housing.

8. An oven for heating food products comprising:
an oven enclosure includes a heat source for heating the food product as the food product moves through the oven enclosure;
a conveyor assembly extending through the oven enclosure;
a drive motor coupled to the conveyor assembly, wherein the conveyor assembly comprises:
a first conveyor section including a driven shaft and an idler shaft each rotatably supported between a pair of spaced side frames and coupled to each other by a first conveyor belt, the driven shaft being connected to the drive motor;
a second conveyor section including a first connecting shaft and a second connecting shaft each rotatably supported between a pair of space side frame members and coupled to each other by a second conveyor belt; and
a gear box positioned between the idler shaft of the first conveyor section and the first connecting shaft of the second conveyor section such that rotation of the idler shaft imparts rotation to the first connecting shaft through the gear box.

9. The oven of claim 8 wherein the gear box includes a first connecting member connected to the idler shaft and a second connecting member connected to the first connecting shaft.

10. The oven of claim 9 wherein the first connecting member and the second connecting member are rotatably coupled to each other.

11. The oven of claim 10 wherein the first and second connecting members each include a sprocket, wherein the sprockets are connected to each other by a linking chain.

12. The oven of claim 9 wherein the first connecting member is received within an open interior of the idler shaft and the second connecting member is received in an open interior of the first connecting shaft.

13. A conveyor assembly for use in moving food products through an oven for cooking, comprising:
a first conveyor section including a driven shaft and an idler shaft each rotatably supported between a pair of spaced side frames and coupled to each other by a first conveyor belt such that rotation of the driven shaft imparts rotation to the idler shaft;
a second conveyor section including a first connecting shaft and a second connecting shaft each rotatably supported between a pair of space side frame members and coupled to each other by a second conveyor belt;
a third conveyor section including a first connecting shaft and a second connecting shaft each rotatably supported between a pair of space side frame members and coupled to each other by a second conveyor belt;
a first gear box positioned between the first idler shaft of the conveyor section and the first connecting shaft of the second conveyor section such that rotation of the idler shaft imparts rotation to the first connecting shaft through the first gear box; and
a second gear box positioned between the second connecting shaft of the second conveyor section and the first connecting shaft of the third conveyor section such that rotation of the second conveyor shaft of the second conveyor section imparts rotation to the first connecting shaft of the third conveyor section through the second gear box.

14. The conveyor assembly of claim 13 wherein the first and second gear boxes each include a first coupling member and a second coupling member each rotatable within the gear box and coupled to each other.

15. The conveyor assembly of claim 14 wherein each of the first and second coupling members includes a shaft portion and a head portion, the shaft portion of the first coupling member being received within an open interior of the idler shaft and the shaft portion of the second coupling member being received within an open interior of the first connecting shaft of the second conveyor section.

16. The conveyor assembly of claim 15 wherein each of the first and second coupling members further comprises a sprocket positioned between the shaft portion and the head portion, each of the sprockets receiving a linking chain.

17. The conveyor assembly of claim 15 wherein the head portion of each of the first and second coupling members includes a bearing that rotatably supports the head portion within a mounting plate.

18. The conveyor assembly of claim 13 wherein the first and second gear boxes are removably supported on the conveyor assembly.
